(19) United States
(12) Patent Application Publication
(10) Pub. No.: US 2013/0181860 A1
(43) Pub. Date: Jul. 18, 2013

(54) RADAR BASED MULTIFUNCTIONAL SAFETY SYSTEM

(71) Applicants: Jialiang Le, Canton, MI (US); Manoharprasad K. Rao, Novi, MI (US); Eric L. Reed, Livonia, MI (US)

(72) Inventors: Jialiang Le, Canton, MI (US); Manoharprasad K. Rao, Novi, MI (US); Eric L. Reed, Livonia, MI (US)

(73) Assignee: FORD GLOBAL TECHNOLOGIES, LLC, DEARBORN, MI (US)

(21) Appl. No.: 13/350,830

(22) Filed: Jan. 16, 2012

(51) Int. Cl. G01S 13/88

(52) U.S. Cl. 342/72

(57) ABSTRACT

A system and method for providing multifunctional safety in a vehicle through a remote sensor is described. The remote sensor is configured to detect surrounding objects through a radar wave at a predefined angle, and within a predefined distance. A control module calculates velocity, severity and likelihood of the object impacting the vehicle through a calculated approach vector of a detected object. The control module further compares the severity of impact, to a pre-determined threshold value, and configures an impact algorithm to initialize and deploy in-vehicle safety systems upon the object crossing a calculated threshold of distance.

### BACKGROUND

This application relates generally to the field of radar based safety systems in vehicles and, more particularly, to multifunctional radar based safety systems.

In conventional vehicles, radar systems are used for a varied set of applications. Such applications include lane change assist system (LCA), cross traffic alert system (CTA), blind spot detection system (BSD), etc., providing assistance to drivers to maneuver vehicles safely. Certain vehicles also include radars, such as forward-looking radars, applied during adaptive cruise control maneuvers, enabling the vehicle to respond according to the proximity of the surrounding traffic or infrastructure.

Some solutions also employ in-vehicle radars or sensors to analyze the possibility of a side or a rear impact. Such systems have helped modern vehicles develop efficient road manners, and have helped reduce accidents and causalities.

With noted advantages of such radar based systems, a multiplicity of such applications in a vehicle may however make the system bulky, complicated and expensive to design and manufacture. Functioning of these systems, depending heavily upon the vehicle's electrical supplies, may burden and consequently drain out, the vehicle's battery sooner than might otherwise be expected. Energy consumption is thus an issue with current known systems. Further, complicated designs may result in interference of one system with similar systems, rendering certain functionalities ineffective or inoperative over time.

Thus there arises a need for an alternative that could enable such systems to function in an efficient, simpler manner, and that would be easier and inexpensive to design, manufacture, incorporate and maintain in vehicles.

### SUMMARY

One embodiment of the present application describes a multifunctional safety system in a vehicle. The system includes a remote sensor located adjacent to a rear corner of the vehicle, the remote sensor including a radar wave covering a field of view at a predefined angle. Further, the remote sensor is configured to detect objects falling within a predefined distance from the vehicle. A control module is configured to receive signals from the remote sensor to calculate an approach vector of an object detected in the field of view, and determine the likelihood of the object impacting the vehicle based on the approach vector. The control module determines the impact velocity and severity of impact of the object, based on the signals received from the remote sensor, and compares the severity of impact to a pre-determined threshold value. An impact algorithm configured with the control module initializes and deploys in-vehicle safety systems when the object crosses a calculated threshold of distance.

Another embodiment of the present application describes a method of operating a multifunctional safety system in a vehicle. The method includes detecting objects within a predefined distance from the vehicle by transmitting and receiving a radar wave generated by a remote sensor. The sensor is located adjacent to a rear corner of the vehicle and covers a field of view at a predefined angle, tracking and classifying the type of objects according to the radar wave reception. After being detected by the remote sensor, an object's approach vector is expressed, relative to the vehicle, and enables a control module to determine an occurrence, velocity and a severity of an impact. Such a state initiates the safety system based on an impact algorithm, configured with the control module, comparing the severity of impact to a calculated pre-determined threshold value. This condition enables the deployment of in-vehicle safety systems when the object is within a calculated threshold of distance.

### BRIEF DESCRIPTION OF THE DRAWINGS

The figures described below set out and illustrate a number of exemplary embodiments of the disclosure. Throughout the drawings, like reference numerals refer to identical or functionally similar elements. The drawings are illustrative in nature and are not drawn to scale.

FIG. 1A illustrates an exemplary vehicular blind spot detection system in the prior art.

FIG. 1B illustrates a vehicle with a blind spot detection system along with an exemplary cross traffic alert system in the prior art.

FIG. 1C illustrates an exemplary cross traffic alert system overlapping the blind spot detection zone in the prior art.

FIG. 2 illustrates an exemplary radar based multifunctional safety system in a vehicle.

FIG. 3 illustrates an exemplary hardware layout of a system in a vehicle according to this disclosure.

FIG. 4 illustrates another hardware layout of a radar based multifunctional system according to this disclosure.

FIG. 5A illustrates a methodology of determining an approach vector of an object moving on a collision course toward a vehicle.

FIG. 5B illustrates an exemplary threshold line in a vehicle equipped with the multifunctional safety system.

FIG. 6 illustrates an embodiment of a radar based multifunctional system with different setting angles.

FIG. 7 illustrates a vehicle using the system depicted in FIG. 6.

FIG. 8 illustrates an exemplary methodology of the functioning of a radar based multifunctional safety system.

FIG. 9 illustrates an exemplary methodology of a side impact protection system according to the present disclosure.

FIG. 10 illustrates an exemplary methodology of a rear impact protection system according to the present disclosure.

### DETAILED DESCRIPTION

The following detailed description is made with reference to the figures. Exemplary embodiments are described to illustrate the subject matter of the disclosure, not to limit its scope, which is defined by the appended claims.

### Overview

In general the present disclosure describes an in-vehicle multifunctional safety system that responds according to objects falling within a close proximity to the vehicle, with likelihood of an impact. To this end, the system may also employ sub-systems, such as Lane Change Assist (LCA), Cross Traffic Alert (CTA), Blind Spot Detection (BSD), and Rear and Side Impact Protection. A remote sensor, mounted to the vehicle, can be configured to detect objects in an area around the vehicle's sides and rear. A situation where an object comes dangerously close to the vehicle, and crosses a calculated threshold of distance, can be sensed by the remote sensor. The remote sensor triggers an in-vehicle control module to intelligently deploy safety mechanisms, even before the object contacts the vehicle. The remote sensor can be configured to have a wide field of view, creating provisions for activating all the above noted sub-systems according to an externally sensed activity, through a singular remote sensor per each side of the vehicle.

### Exemplary Embodiments

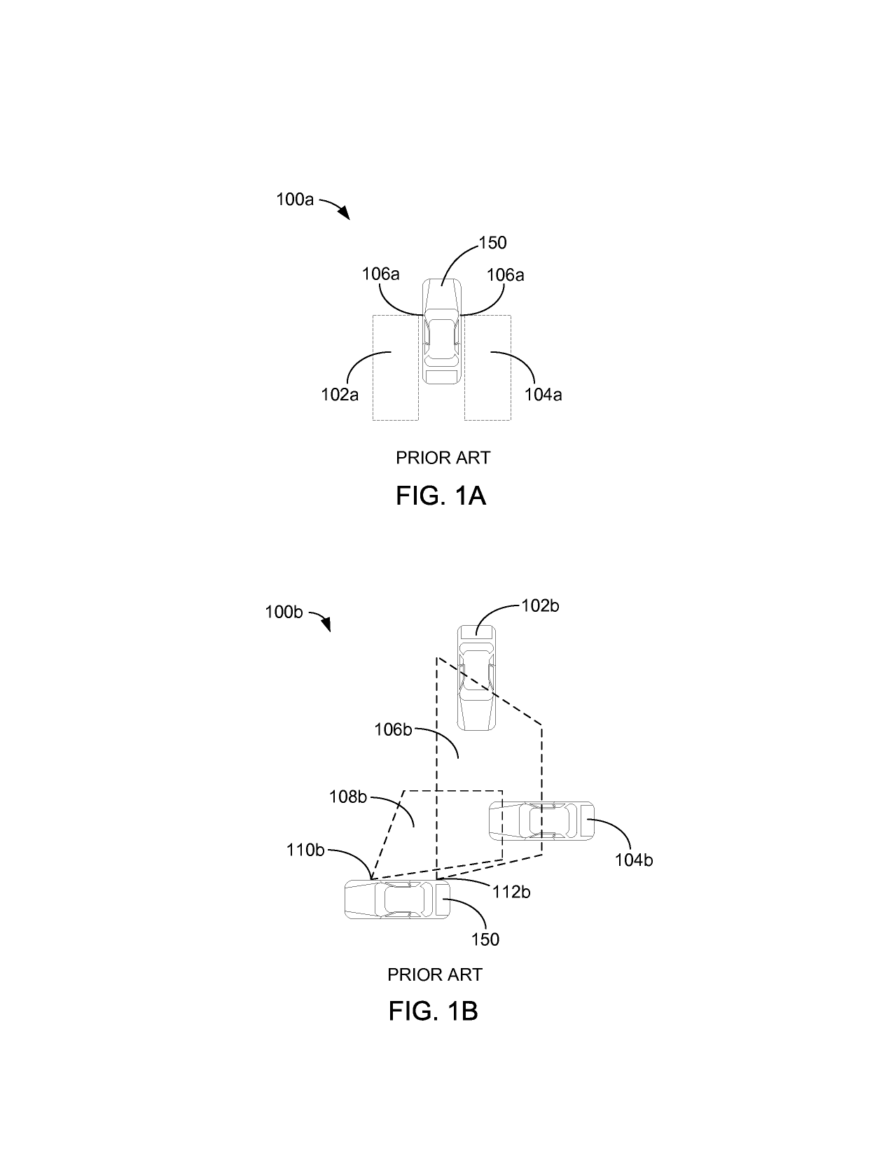

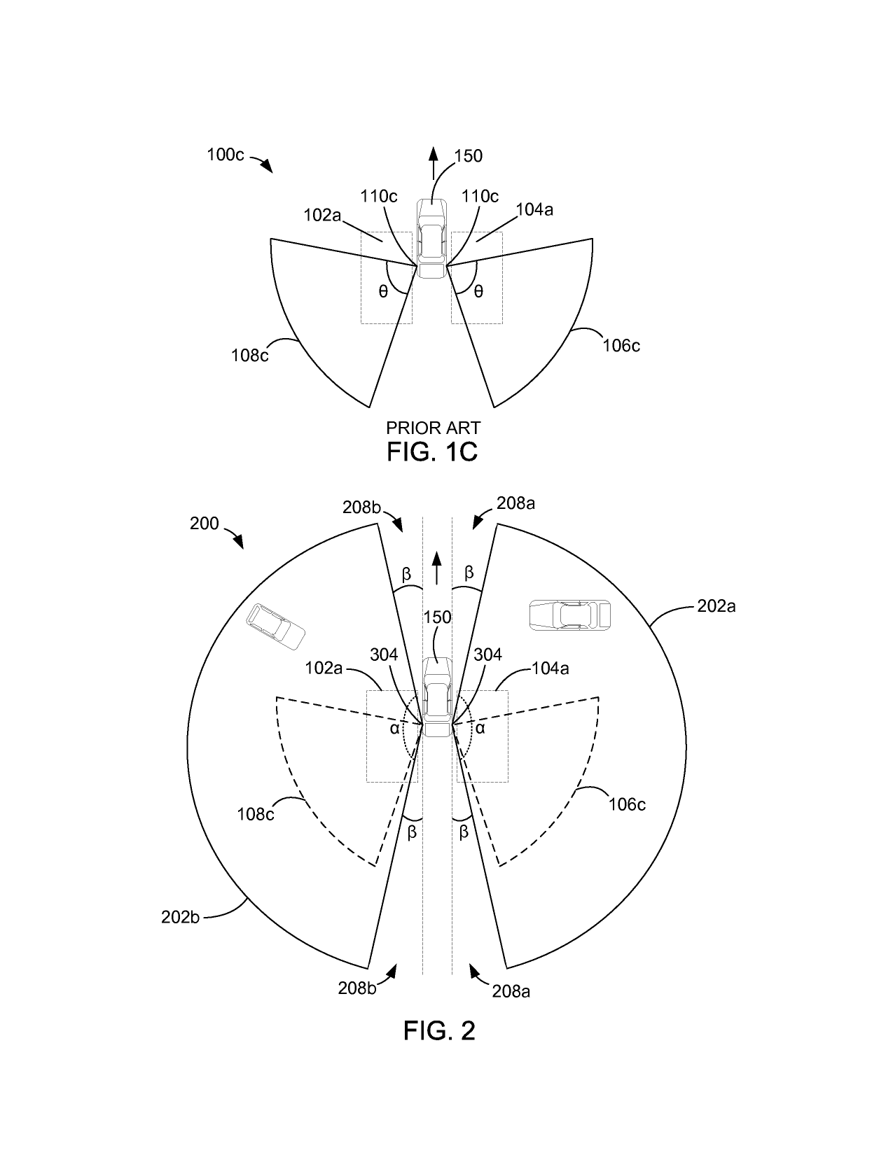

FIG. 1 illustrates a conventional blind spot detection system (BSD) 100a employed in a host vehicle 150 with a left side blind spot 102a, and a right side blind spot 104a. Such spots include areas that do not fall directly in the driver's line of sight, and in many cases are not visible through the rear view mirrors as well. Blind spot detection systems currently employed in vehicles detect the presence of objects in the specified spots through radar waves transmitted through sensors 106a. The radar waves are configured to cover a field of view at a predefined angle and within a predefined distance from the host vehicle 150. Such detection systems function to alert the driver and/or in-vehicle systems to respond according to the detected presence of an object, in either of the blind spots.

Some blind spot detection systems with longer rearward object detection ranges provide lane change assist system (LCA) for the host vehicle 150. LCA system assists the driver in performing the lane change tasks by indicating the presence of other vehicles traveling in the same direction in the near by lanes which may be too close for the host vehicle 150 to perform the lane change function in a safe manner. Such systems are widely known as lane change assist (LCA) systems and are well known to those skilled in the art.

FIG. 1B depicts a conventional vehicular safety system 100b, configured on one side of the host vehicle 150, comprising dual remote sensors. One remote sensor is a front sensor 110b positioned towards the front of the host vehicle 150, and the other remote sensor is a rear sensor 112b positioned towards the rear. The front sensor 110b enables a BSD system, similar to FIG. 1A, to scan the surroundings of the host vehicle 150, while in motion. As shown, another target vehicle 104b in the blind spot zone 108b may be scanned and monitored during a forward maneuver through the front sensor 110b, enabling certain measures to avoid possible collisions. Systems such as BSD and LCA may thus function well through an arrangement of the front sensor 110b as disclosed. The BSD systems discussed in FIG. 1B may maintain functionalities similar to those mentioned in connection with FIG. 1A.

During a reversing maneuver, an activation of the rear sensor 112b could enable the detection of a target vehicle 102b, and its proximity to the host vehicle 150. Such activations, known as cross traffic alert systems (CTA), may function at driveways, parking lots, etc., scanning a larger area 106b at the rear sides of the host vehicle 150, as shown. Upon the possibility of an impact, vehicular braking and restraints measures could be activated, enabling appropriate responses to safeguard vehicle occupants. Placement of the remote sensors, as noted above, could be altered and placed closer to each other, either towards the front, or the rear of the host vehicle 150, while maintaining the same functionalities. Systems and alterations such as noted above are well known to those skilled in the art.

Combining the front sensor 110b and the rear sensor 112b together and enabling both functionalities of BSD and CTA together, finds wide applications in modern vehicles as well. FIG. 1C accordingly depicts a similarly configured combined system 100c, with the CTA regions marked as 106c and 108c covers over half of the left side blind spot 102a and the right side blind spot 104a, respectively. A single sensor 110c positioned on either sides of the host vehicle 150, with a larger scanning range and placed towards the rear of the host vehicle 150, as shown, may thus enable both functionalities of BSD and CTA. The position of the single sensor 110c and its zone of coverage may be altered according to the zones desired to be covered based on the host vehicle's travel direction.

FIG. 2 illustrates an exemplary radar based multifunctional safety system 200 incorporated in the host vehicle 150. As shown, the system 200 includes a remote sensor 304 located adjacent to a rear corner of the host vehicle 150, providing a wider field of view, as shown by areas 202a and 202b. In the illustrated embodiment, the predefined angle α covered by each of the fields of view is 150°, and the angle β is 15°. The remote sensor 304, applied in the present configuration, is a multi-beam 24 GHz radar, which covers an area roughly up to a predefined distance of 30 meters from the host vehicle 150. A similar coverage zone can be accomplished using single lobe, multi-lobe or electronic scanning radar operating at a number of different frequencies such as 24, 26, 77, 78 GHZ etc. Such a sensor arrangement enables the sensing of objects and vehicles up to an extended area and to a larger range of distances, enabling all the functionalities of BSD, CTA, and LCA, to be incorporated into a single radar based system. In addition, the wider field of view, as shown through the areas 202a and 202b, may enable the system 200 to incorporate certain additional functionalities and sub-systems for side and rear impact protection, as well.

The field of view at an angle of 150°, made by the remote sensor 304, may be altered according to varied vehicular size and shape requirements. In addition, different vehicular applications and environments, may also determine the angle and the extent of the field of view required. For example, in motor sport events, the possibility of vehicular collision is higher, so a remote sensor installed in a vehicle may be enabled to cover a field of view at an angle of 270°. Such configurations would enable the detection of objects and vehicles falling within a field of view that ranges up to 3 quadrants around the host vehicle 150. Military vehicles may also be equipped with radar systems that cover an extended field of view. It has, however, been observed that costs incurred for maintaining such configurations are higher, and thus radar systems, such as the system 200 installed in commercial vehicles, may be enabled to cover only an optimum field of view at an angle of 150°, maintaining a balance between the cost and functionality.

In the disclosed embodiment, with the remote sensor 304 enabling a field of view at an angle of 150°, it will be understood that certain blind zones would however exist outside the field of view. As noted, areas 208a and 208b are blind zones existing on either sides of the host vehicle 150. Objects entering this area would remain undetected.

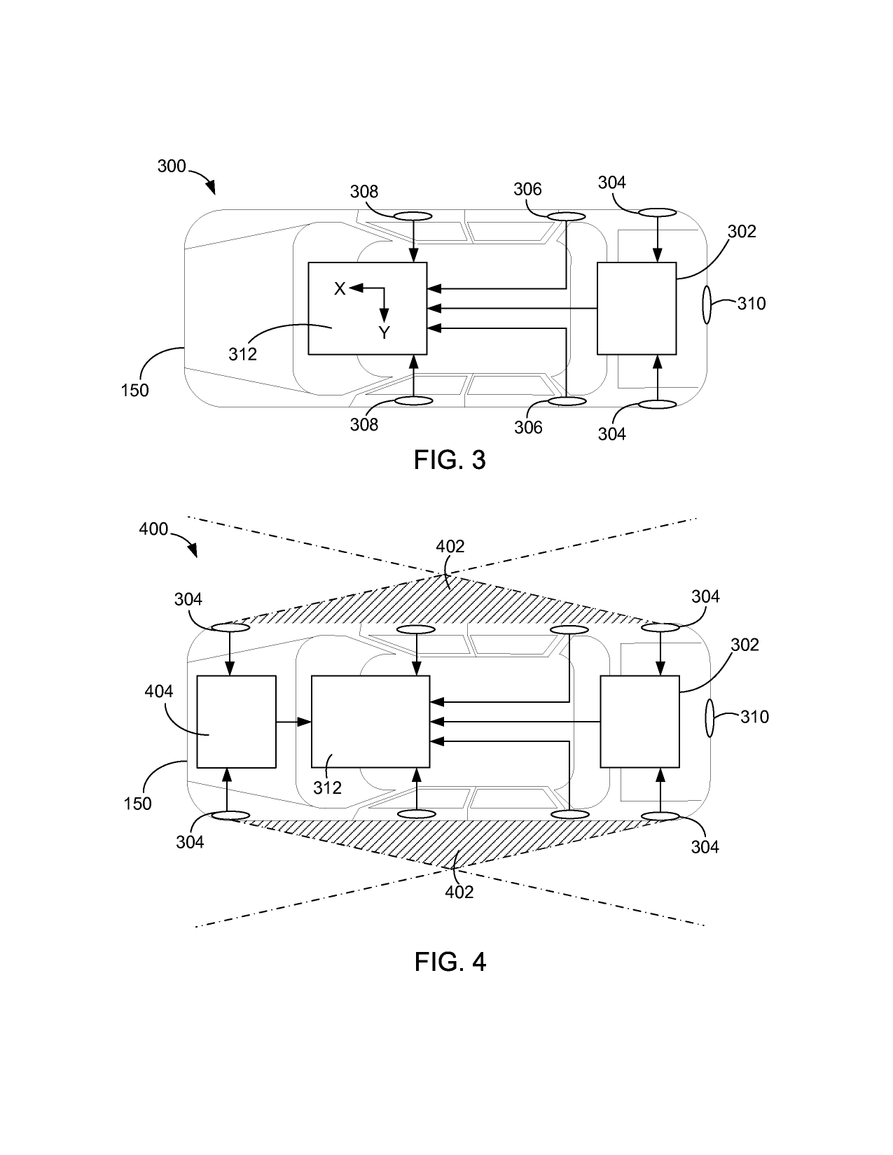

FIG. 3 illustrates the hardware layout 300 of a radar based multifunctional safety system 200 installed in the host vehicle 150. The hardware layout 300 comprises remote sensors 304, positioned opposite to each other, at the rear ends of the host vehicle 150, in a way that could enable the remote sensors 304 to provide optimum coverage of the BSD zones. Pressure sensors 308 may be included in the front doors to sense impact pressure, along with lateral (y-axis) accelerometers 306 on the back doors of the host vehicle 150. More particularly, the remote sensor 304 utilized here may be a multi-beam 24 GHz radar with Doppler measurement capabilities. A camera 310, attached to the rear of the host vehicle 150, may enable detecting objects at the vehicle's rear, thereby protecting the host vehicle 150 from rear impacts. However, some configurations are possible that could avoid any vision based rear system, such as the camera 310, to monitor objects at the rear.

Certain microprocessor-based signal processing units, such as a radar processor 302, may be incorporated to process raw signals obtained from the remote sensors 304 and feed it to a control module such as a Restraint Control Module (RCM) 312. RCM 312 may thus receive inputs in the form of compatible and processed signals from the pressure sensors 308, accelerometers 306 and the remote sensors 304, which in turn may signal in-vehicle safety systems, such as seat belts, headrests, airbags, etc., to respond appropriately to any detected danger.

The RCM 312 may be a microprocessor-based device well known in the art, having a central processing unit, volatile and non-volatile memory units, along with associated input and output buses. More particularly, RCM 312 may be based on an application specific integrated circuit or other logic devices known in the art, and in turn may include accelerometers for sensing crash pulses along both the X and the Y axis. The RCM 312, or a similar control module, may carry out conventional blind spot detection and warning functions based on signals received from the remote sensors 304, indicating the presence of an object in the blind zone.

Vehicles running under certain environments, requiring the utmost protection from external objects, can adopt an alternate hardware configuration 400, as shown in FIG. 4. Remote sensors 304 placed on all four corners of the host vehicle 150, enable detection of objects falling even under the blind zones as shown by the areas 208a and 208b in FIG. 2. A small area 402, however, remains as an undetected blind zone in the disclosed configuration. More particularly, in such a configuration, an additional radar processor 404 could be incorporated, enabling functionalities to be carried out in a timely fashion, similar to the ones described in connection with FIG. 3.

Similar to the hardware layout 300, vision based systems may be incorporated in the host vehicle 150 for detecting an object at the rear, to provide protection from a potential impact. For this, a camera 310 may be fixed at the back of the host vehicle 150 to provide visual information at the rear.

Radar based systems, as discussed, are configured to detect objects or vehicles falling within a predetermined distance from the host vehicle 150, providing an impact protection system. Such impact protection systems utilize advanced techniques to calculate and track the range and range rate of an object, approaching as a target object to determine the approximate impact location and severity.

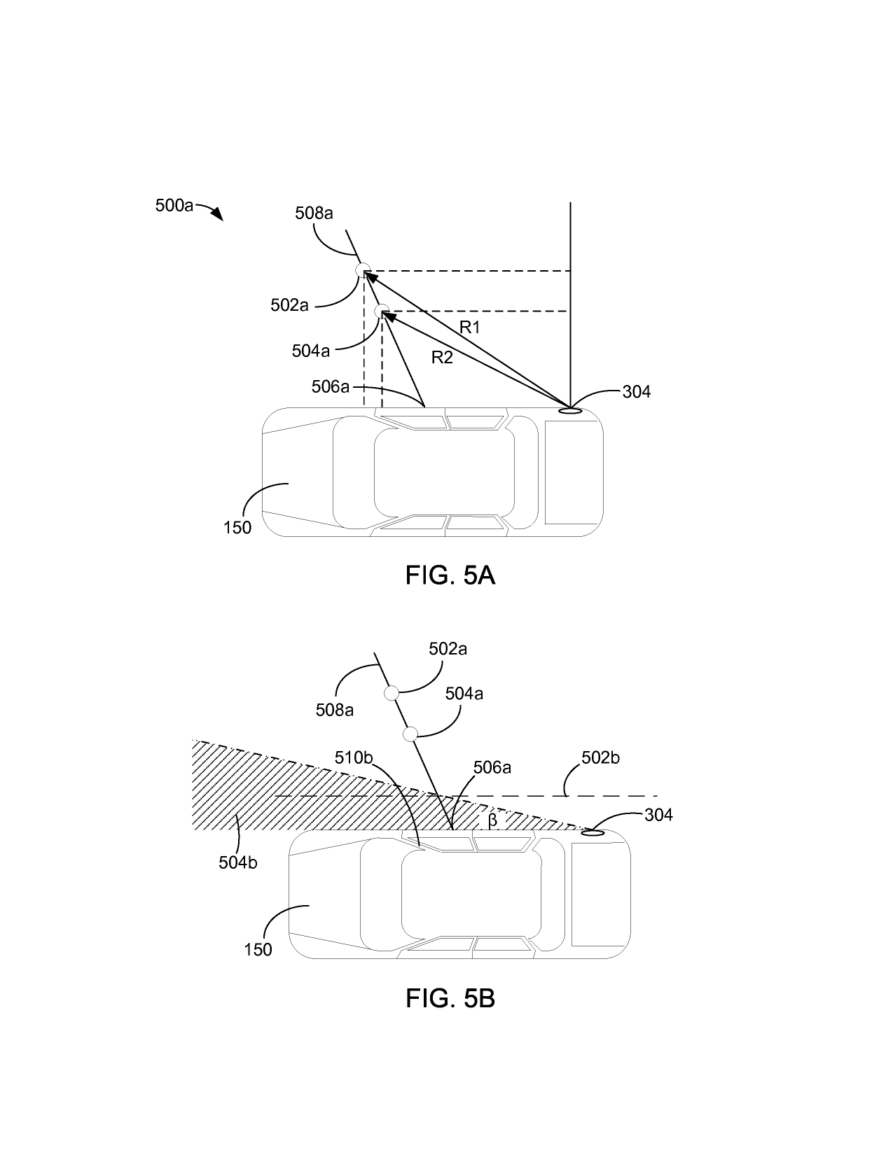

Accordingly, FIG. 5A illustrates a calculation methodology 500a of an exemplary radar based system detecting a target object (not shown), the target object running on a collision course to the right side of the host vehicle 150. Once detected by radar waves R1 and R2, a calculation and expression of an approach vector 508a of the target object is performed through the RCM 312 by tracking the target object as it moves relative to the host vehicle 150 from a first detected position 502a to a second detected position 504a. Based on the approach vector 508a, the detected positions 502a and 504a, and through a timer (not shown) configured within the RCM 312, certain requisite aspects of the target object impact may be established, such as a likelihood of impact, relative direction of impact, expected impact location, impact velocity, and a magnitude or severity of impact, on one of the sides of the host vehicle 150. The impact velocity may be calculated and determined as a function of the distance calculated between the detected positions 502a and 504a, to the time taken by the target object to travel from the position 502a to the position 504a. The time, as noted, is configured to be calculated through the timer. In addition, the severity of impact may also be determined, and is calculated as a function of the impact velocity, and the type of the object, the type being classified through the RCM 312, and the classification ranging from a truck to a motorbike. A range of severity of the impact may thus be obtained as high, medium, or low, or a specific impact severity value may be reached at through the RCM 312, the impact severity value depending upon the velocity of the impact. All such aspects enabling appropriate responses from in-vehicle safety systems may be determined and calculated based on the signals received and from the remote sensor 304, and analyzed through the RCM 312. Such responses are particularly assisted through the comparison of the severity of the impact to a threshold value, calculated through the RCM 312. It will be understood that the calculated threshold value is a least impact severity value which causes injury to a vehicular occupant. Alternatively, the threshold value may be a predetermined value adapted to be stored within the RCM 312. Further, the velocity of the target object, as described, could also be established through Doppler technology.

As seen in FIG. 5B, a remote sensor 304 located near the right rear corner of the host vehicle 150 may have an angular radar-blocked zone 504b. This radar-blocked zone 504b, lying close to the side of the host vehicle 150, is indicated in cross-hatch, and is not covered by the field of view of the remote sensor 304. As noted above, the field of view adequately covers the zones for BSD, LCA, CTA and side impact protection. The radar-blocked zone 504b may begin at a line approximately 15° outward from the side of the host vehicle 150, starting from the remote sensor 304.

A threshold line 502b may be a calculated at a predefined threshold of distance from either sides of the host vehicle 150 depending upon a scanning range of the remote sensor 304, and the velocity of the target object.

The threshold line 502b of the target object can be determined through trigonometric calculations. For instance, if the distance (measured along the x-axis) between the remote sensor 304 and the approximate impact location 506a, representing a point near a vehicle's ‘A’ pillar 510b is 3 meters, then radar-blocked zone 504b will extend approximately 0.8 m along the y-axis from the approximate impact location 506a. This distance is indicated by the threshold line 502b in the figure. It will be understood that in case of an impact towards the rear door, the blocked zone width will be less than 0.8 m.

When a target object (not shown) travelling along the approach vector 508a crosses the threshold line 502b and enters radar-blocked zone 504b, radar target detection must necessarily cease, however radar processor 302 and/or RCM 312 continue to estimate the track of the target object (based upon last known position and relative velocity) until a collision between the target and the host vehicle 150 is confirmed by the pressure sensor 308 and accelerometer 306. Known techniques for signal filtering and prediction may be used to accurately track and predict the path of the target object. For example, Kalman filtering technique.

It is possible for a target object to approach the host vehicle 150 on a collision-course from the right-rear quadrant, and therefore be detected by the remote sensor 304 covering the blind-spot detection zone in that quadrant. Similar tracking and vector calculations as described above are performed in such a case.

An impact algorithm is preferably initialized through the RCM 312 at or just prior to when the target object crosses the threshold line 502b, threshold line 502b being calculated through the RCM 312. Algorithm initialization may include (but is not limited to) switching from a steady state or “stable” mode to a crash-preparatory or “active” mode. In the active mode, the computer resources of RCM 312 may focus on side impact prediction and detection. RCM 312 may receive data/signals primarily from the remote sensors 304, and perform calculations at a higher data-rate than in the stable mode. For example, the signals from pressure sensor 308 and/or accelerometer 306 and from vehicle state sensors, such as Inertial Measurement Unit (IMU) and wheel speed sensors (not shown), may be received at higher data rates. Accordingly, the side impact algorithm begins earlier and runs faster than is possible if only information from pressure sensors 308 and accelerometers 306 is relied upon.

The side impact algorithm may involve activation and deployment of the appropriate in-vehicle safety or restraint device when the detected level of pressure and/or acceleration (depending upon the pressure sensor 308 or the accelerometer 306) reaches a threshold value which is lower than a contact only (non-predictive) impact threshold value used in the absence of any predictive, pre-contact information from the remote sensor 304. The resulting reduction in restraint deployment time is achieved without the cost of having added additional remote sensor equipment to the host vehicle 150. The impact algorithm is thus configured with the RCM 312 to initialize and deploy in-vehicle safety systems when the target object crosses a calculated threshold of distance.

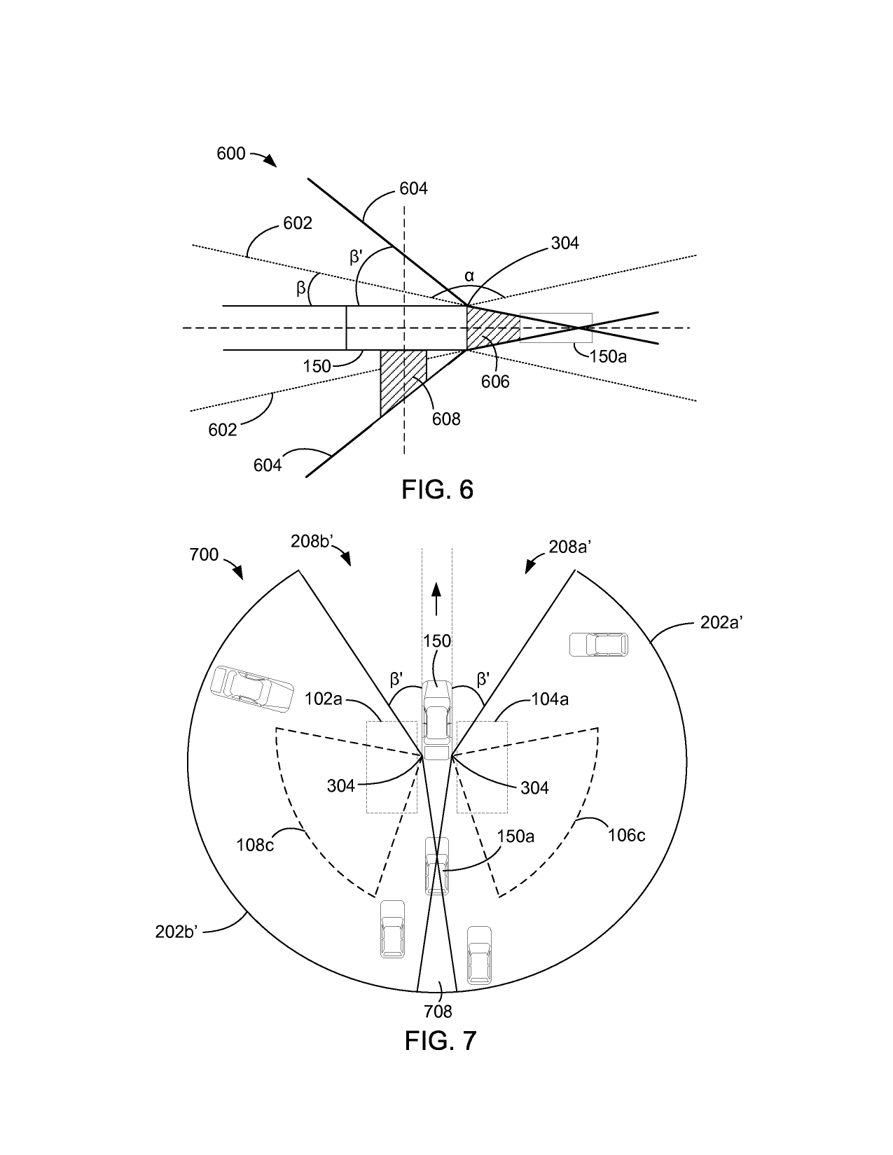

Rear impacts can be similarly sensed through a similar system. Variations in the remote sensor 304 settings may enable different zones around the host vehicle 150 to be covered. FIG. 6 depicts a radar based multifunctional safety system 600, having remote sensors 304 installed with different zone coverage. The system 600 may function similarly to the one described in connection with FIG. 2, however, different setting angles of the remote sensor 304 may enable the rear of the host vehicle 150 to be monitored, as well. A first setting 602 is similar to the technology discussed so far. A change however, in the setting of the remote sensors 304, to look like setting 604, may enable the field of view of the remote sensor 304, positioned on either sides of the host vehicle 150, to intersect each other at the rear of the host vehicle 150, as shown. The areas 606 and 608 show blind zones in the setting 604. With the angle of the field of view a maintained at a constant 150°, angle β may change to β′ at the front of the host vehicle 150, ranging between 37° and 45°, and fixed according to an optimum range calculated during the vehicle's design for safety. A threshold line similar to the threshold line 502b may exist in such a setting, whose calculation and functionality may remain similar to the one previously described. Through such a configuration, a vehicle 150a may thus be detected at the rear of the host vehicle 150.

Factors required for the determination of certain vehicular safety aspects such as positioning of the remote sensor 304 (setting angles), angle of the field of view etc., during the design stage are; vehicular side blind distance (SBD) and rear blind distance (RBD). Both these aspect can be expressed according to the following relation:

SBD=(HL/2)·tan(β)

RBD={(HW−TW·Coef)/2}·tan(270−α−β)

### Where,

α: Angle of field of view of the remote sensor 304.
β: Radar setting angle in relation to the vehicle.
HL: Length of the host vehicle 150.
HW: Width of the host vehicle 150.
TW: Target vehicle width.
Coef: Effective coefficient for radar detectable target.

FIG. 7 depicts a multifunctional radar based safety application 700 of the setting 604 of the remote sensor 304 as discussed in the previous figure. As depicted, even though a considerable area in front of the vehicle experiences a blind spot, the setting 604 may function well to detect objects and vehicles on the sides and the rear, enabling positive rear and side impact protection, along with CTA, LCA, BSD, etc. Vehicle 150a could thus be monitored well through the setting 604. The setting 604 however experiences a small redundant overlapping area 708. As noted above, it will be understood that the application 700 would suffer from wider blind zones in the front of the host vehicle 150, than what has been depicted for system 200 in FIG. 2. Accordingly, area 208a, as shown in FIG. 2, becomes larger for the application 700, and thus corresponds to a wider area 208a′ in FIG. 7, and area 208b in FIG. 2 corresponds to a wider area 208b′ in FIG. 7. Similarly, the field of view shown by the area 202a in FIG. 2, corresponds to a region 202a′ in FIG. 7, and the area 202b in FIG. 2, corresponds to a region 202b′ in FIG. 7.

Rear impact protection systems may alternatively incorporate a vision based system, or a camera at the back of the host vehicle 150, that may enable reduction of such blind zones in the front of the host vehicle 150, by aligning the remote sensor 304 as noted in FIG. 2. Being similar in arrangements to the camera 310 discussed in connection with FIG. 3, such a system however may require additional units to intelligently manage impacts from the rear. Accordingly, the vision-based system may include processors to process the incoming visual signals, and algorithms to analyze the images and activate corresponding in-vehicle restraint mechanisms to safeguard the occupants. It will be understood that a configuration such as this may incur additional system complexity to the host vehicle 150.

With the application of BSD, LCA and CTA being known in the art, the methodology of incorporating side and rear impact sub-systems into the application 700 is discussed as follows.

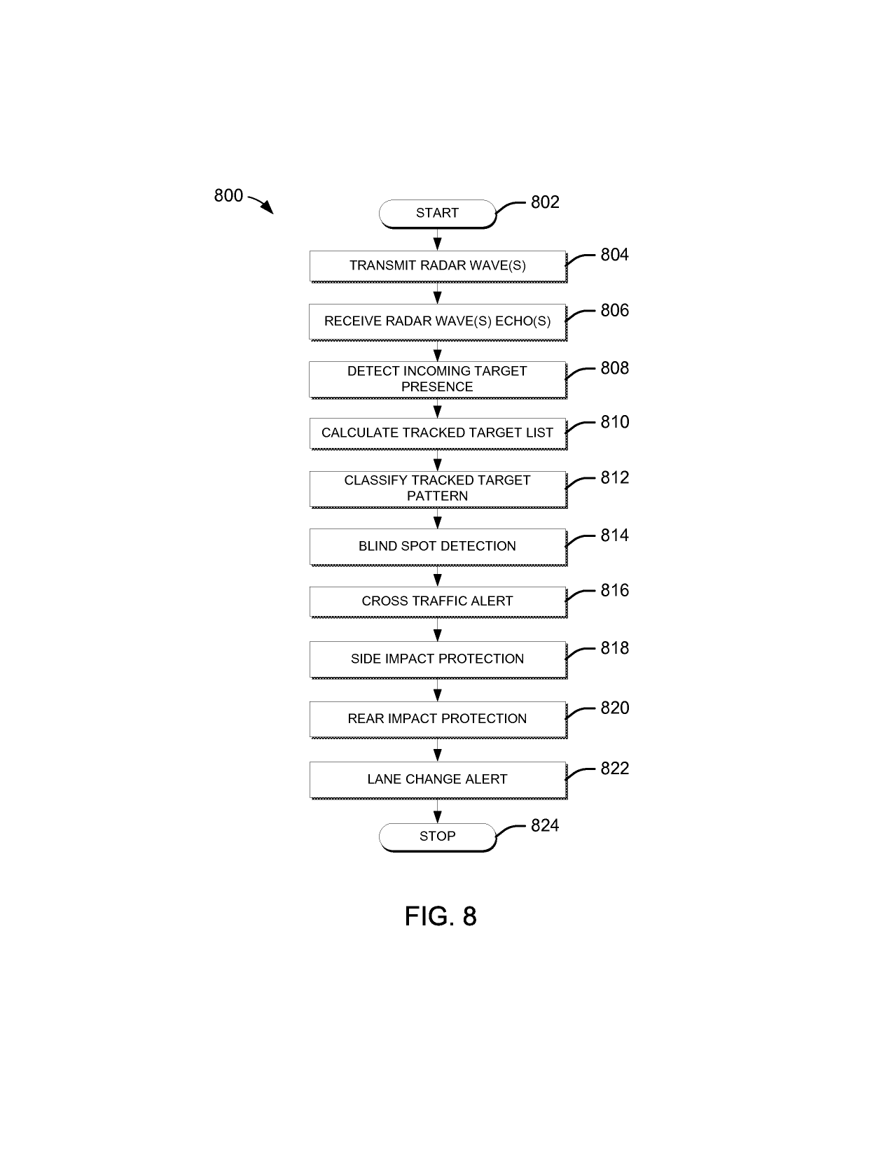

FIG. 8 describes an exemplary method 800 of functioning of the multifunctional radar based safety application 700. At any point during the course of run of the host vehicle 150, the application 700 continuously monitors objects falling within its field of view. At stage 802, the application 700, having a wide field of view, may start functioning as soon as the vehicle starts operation. Provisions, however, could be made for an optional start through a man-machine interface disposed within the vehicle confines. At stage 804, the remote sensor 304 transmits radar waves, monitoring objects falling within its field of view. Reception of the transmitted waves after its reflection from objects present in the field of view, could initiate the detection and tracking of such objects at stage 806. Further, at stage 808, based on the incoming signal, the application 700 detects the presence of an incoming target in the field of view of the remote sensor 304. Since an environment around the host vehicle 150 could comprise multiple vehicles, providing multiple reflection points and surfaces, the application 700 may receive a multitude of such reflected signals from more than one source. The application 700 thus tracks and clusters such signals, and calculates the tracked target list, checking whether the signals belong to a singular object, or multiple objects. For example, a multiplicity of signals being received by the application 700, from an object, at the same rate, time and at a constant incoming velocity of the object, would differentiate whether the object is a two wheeler or a truck, or discriminate between a moving vehicle and a stationary pole. Thus, the tracking and classification of the type of objects is performed in stage 808, following which detection of such an incoming object is carried out in stage 810. At the next stage 812, the classification of the nature of danger is addressed according to a radar wave reception. The application 700 classifies the tracked target pattern and determines the nature of the possible impact. For instance, if a vehicle is approaching the host vehicle 150 from the rear, it will be understood that the system must respond and initiate vehicular restraints that could protect the occupants from a rear impact, instead of activating restraints that protect during a side impact. Similarly, a CTA being different from a LCA, the application 700 cannot initiate LCA to cross traffic alert situations. Accordingly, the application 700 activates one or more of the sub-systems such as BSD, CTA, Side impact protection, rear impact protection or LCA according to the danger detected. This happens in the respective stages of 814, 816, 818, 820, and 822. The application 700 eventually stops functioning at the last stage 824, when a vehicular run is accomplished. In addition, an optional man-machine interface could be provided in the host vehicle 150 to stop or deactivate the application 700.

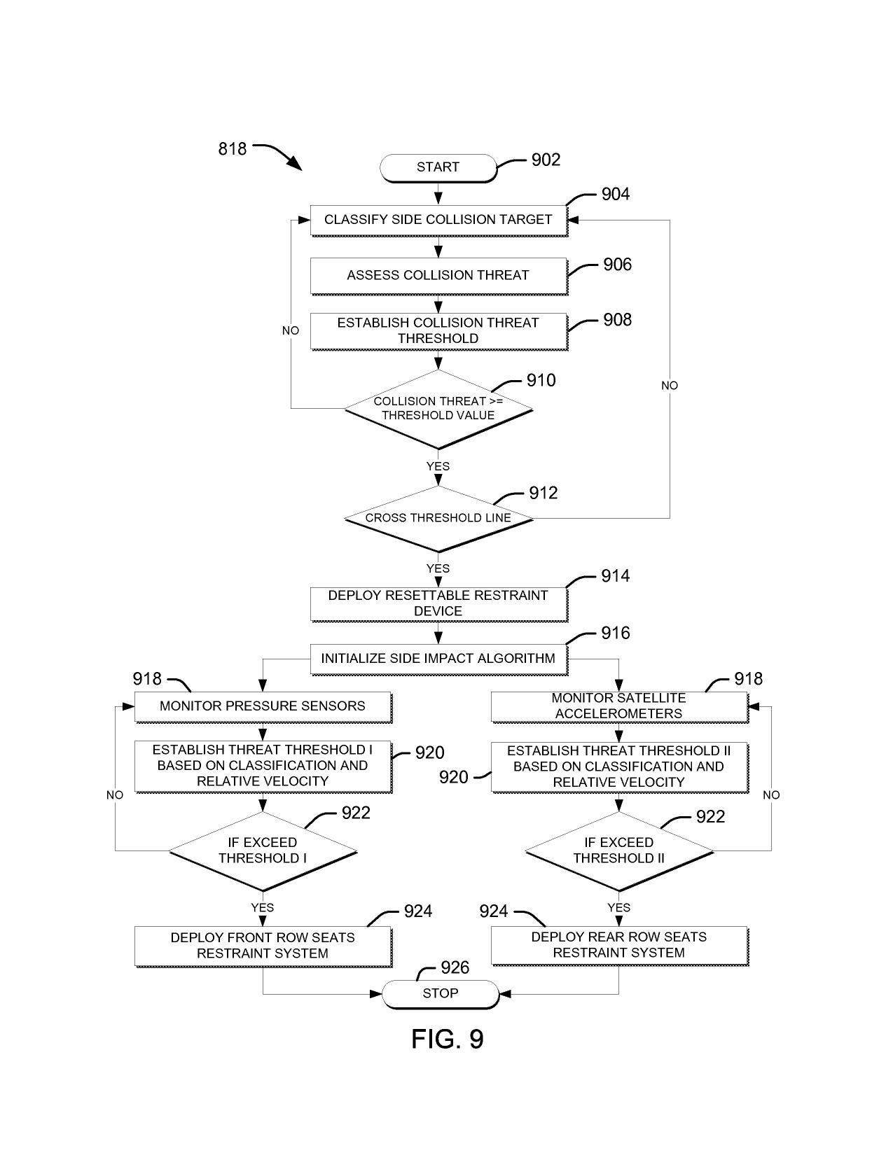

FIG. 9 depicts the side impact protection sub-system 818, as noted above. At stage 902, the sub-system 818 starts functioning as part of the application 700 in the host vehicle 150. At stage 904, the sub-system 818 classifies any incoming side collision target that helps in differentiating between objects, such as a car and a motorbike. A collision threat is assessed and determined based upon the relative velocity of the incoming object in relation to the host vehicle 150, in the next stage 906. Upon the possibility of an impact, assessment of collision threats forms inputs for configuring a collision threat threshold. Such threshold calculations are performed in the next stage 908, and are configured to provide values of the magnitude or severity of impact through the RCM 312.

The following stage 910 confirms whether the collision threat is lesser or greater than the calculated threshold value. If the threat is found to be lesser, the sub-system 818 may be alerted back to the stage 904 and revert to monitoring surrounding objects. If however, the threat is found to be greater than the threshold value, the sub-system 818 proceeds to the next stage 912, to configure a threshold line and wait until the incoming object crosses the threshold line. If the incoming object crosses the threshold line, the sub-system 818 proceeds to the next stage 914, otherwise the sub-system 818 may again be alerted back to the stage 904. It will be understood that the threshold line is similar in functionality to the threshold line 502b discussed in connection with FIG. 5B.

The moment the incoming object crosses the threshold line, at stage 914, resettable restraints, such as seat belts, resettable side bolsters, etc., are deployed. Consequently, a side impact algorithm is initiated in the next stage 916 to actively monitor side pressure and accelerometer sensors. At stage 918, thus both the pressure sensors 308 and the accelerometers 306 are monitored constantly. As signals from the incoming object are being received by the remote sensor 304, the thresholds for the pressure sensors 308 and accelerometers 306 are lowered and established at stage 920, based on the object's classification and the relative velocity. Further, at stage 922, if the sensor signals exceed the established thresholds, the in-vehicle restraints are activated. Such activation at the subsequent stage 924 has an advantage of being a few milliseconds earlier than conventional systems, safeguarding the vehicular occupants in a timely fashion. After the activation and consequent deployment of the restraints, the sub-system 818 finally stops functioning and exits at stage 926.

As noted above, at stage 920, if the object detected is developing a lower velocity as it approaches for an impact, the thresholds for the pressure sensors 308 and the accelerometers 306 may not be lowered, since a minor impact need not necessitate an airbag deployment.

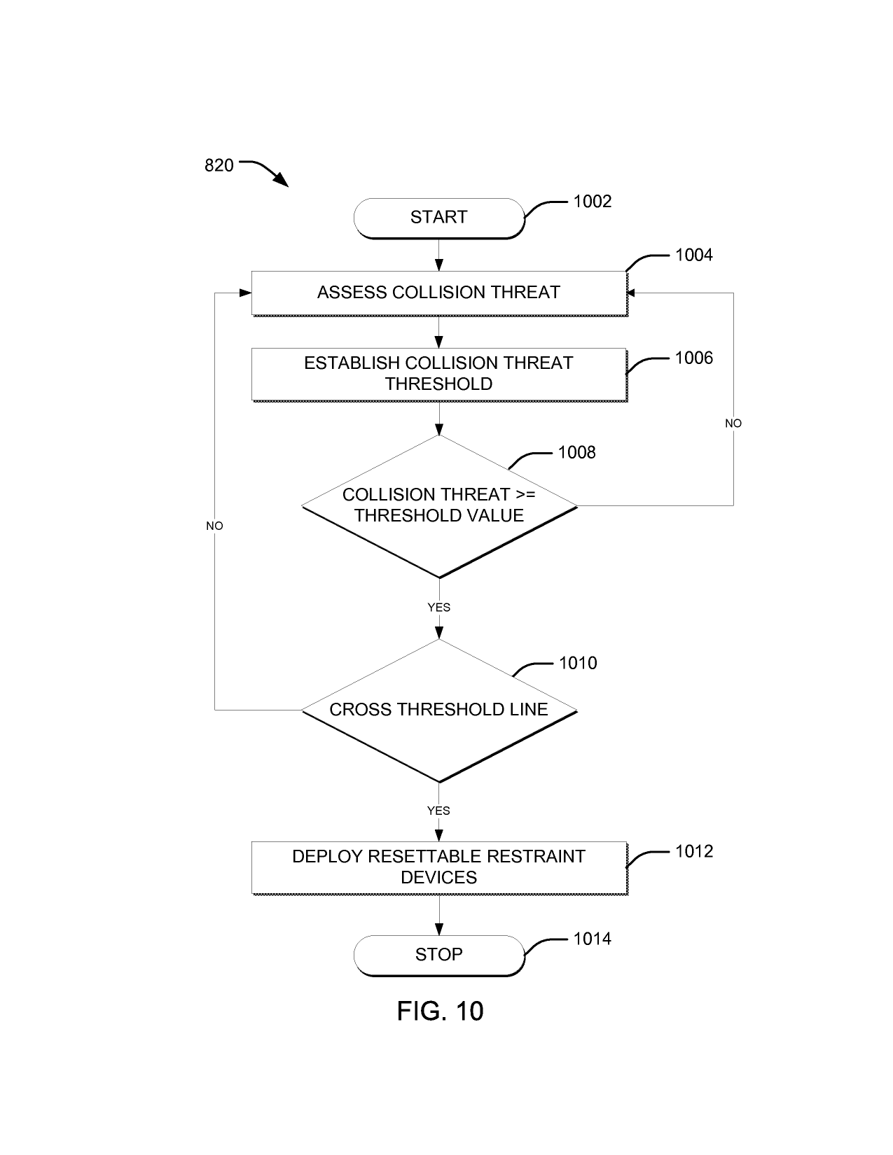

FIG. 10 depicts a similar sub-system 820, within the multifunctional radar based safety application 700 that focusses on rear impact protection in the host vehicle 150. Accordingly, the sub-system 820 starts functioning at stage 1002. Starting could be initiated automatically along with the vehicle's ignition systems, or provided through a man-machine interface provided within vehicular confines. An assessment of a collision through an object, from the rear, is carried out in the following stage 1004. Such assessments are based upon the signals received from the object being monitored by the remote sensor 304. A threat threshold is thus determined upon the possibility of an impact, assessment of collision threats forming inputs for configuring a collision threat threshold, all in stage 1006.

At stage 1008, if the collision threat value is found to be lesser than the threshold value, the sub-system 820 reverts back to the stage 1004 of monitoring surrounding objects. On the other hand, if the collision threat is found to be greater than the threshold value, the sub-system 820 initiates in-vehicle safety and restraint systems and waits for the object to cross a threshold line at stage 1010, the threshold line being similar to the threshold line 502b discussed in connection to FIG. 5B. Such initiation is based upon the impact algorithm configured with the RCM 312. Upon crossing the threshold line, the sub-system 820 functions to deploy resettable restraint devices, before an impact at stage 1012. The application 700 thus protects the vehicular occupants from impacts at the rear by initiating and deploying in-vehicle safety systems in a timely fashion, through constant monitoring of the surroundings.

Finally, once the impact has occurred and in-vehicle restraints are deployed, at stage 1014, the sub-system 820 may function to stop and exit operation, or may return to the beginning of the operation.

The functioning of the other safety systems, such as the BSD, LCA, and CTA, depicted in FIG. 8, are well known to those skilled in the art, and is thus not discussed in the present disclosure.

The specification has set out a number of specific exemplary embodiments, but those skilled in the art will understand that variations in these embodiments will naturally occur in the course of embodying the subject matter of the disclosure in specific implementations and environments. It will further be understood that such variation and others as well, fall within the scope of the disclosure. Neither those possible variations nor the specific examples set above are set out to limit the scope of the disclosure. Rather, the scope of claimed invention is defined solely by the claims set out below.

We claim:

1. A multifunctional safety system in a vehicle, the system comprising:
a remote sensor located adjacent to a rear corner of the vehicle, the remote sensor including a radar wave covering a field of view at a predefined angle, the remote sensor configured to detect objects falling within a predefined distance from the vehicle;
a control module configured to receive signals from the remote sensor to calculate an approach vector of an object detected in the field of view, and determine the likelihood of the object impacting the vehicle based on the approach vector, the control module determining the impact velocity, impact location and severity of impact, based on the signals received from the remote sensor, and compare the severity of impact to a calculated threshold value; and
an impact algorithm configured with the control module to initialize and deploy in-vehicle safety systems upon the object crossing a calculated threshold of distance.

2. The system of claim 1, wherein the multifunctional safety systems comprises at least one of:
blind spot detection system;
lane change assist system;
cross traffic alert system; or
impact protection system.

3. The system of claim 1, wherein the remote sensor is a multi-beam 24 GHz radar.

4. The system of claim 1, wherein the remote sensor is an electronic scanning radar with scanning frequencies in 24 to 78 GHZ range.

5. The system of claim 1, wherein the calculated threshold value is a least impact severity value which causes injury to a vehicular occupant, the impact severity value depending upon the velocity of the impact.

6. The system of claim 1, wherein the calculated threshold of distance is based on a distance from one or more sides of the vehicle, the calculated threshold of distance is dependent on at least one of scanning range of the remote sensor, and velocity of the object.

7. The system of claim 1, wherein the velocity of the object is determined using Doppler technology.

8. A method of operating a multifunctional safety system in a vehicle, the method comprising:
detecting objects within a predefined distance from the vehicle by transmitting and receiving a radar wave by a remote sensor, the sensor being located adjacent to a rear corner of the vehicle and covering a field of view at a predefined angle;
tracking and classifying the type of objects, the classification being performed according to the radar wave reception, a response to be established through the multifunctional safety system;
expressing an approach vector of an object to determine a likelihood of impact through a control module based upon reception of signals from the remote sensor;
determining a velocity and severity of impact through the control module;
initiating an in-vehicle safety system based on an impact algorithm configured with the control module;
comparing the severity of impact to a calculated threshold value; and
deploying in-vehicle safety systems when the object is within a calculated threshold of distance from the vehicle.

9. The method of claim 8, wherein the in-vehicle safety system comprises at least one of:
blind spot detection system;
lane change assist system;
cross traffic alert system; or
impact protection system.

10. The method of claim 8, wherein the velocity of the object is determined using Doppler technology.

11. The method of claim 8, wherein the remote sensor is a multi-beam 24 GHz radar.

12. The method of claim 8, wherein the remote sensor is an electronic scanning radar with scanning frequencies in 24 to 78 GHZ range.

13. The method of claim 8, wherein the calculated threshold value is a least impact severity value which causes injury to a vehicular occupant, wherein the impact severity value depends upon the velocity of the impact.

14. The method of claim 8, wherein the calculated threshold of distance is based on a distance from one or more sides of the vehicle, the calculated threshold of distance is dependent on at least one of scanning range of the remote sensor, and velocity of the object.
